(19) United States
(12) Patent Application Publication
(10) Pub. No.: US 2023/0008844 A1
(43) Pub. Date: Jan. 12, 2023

(54) DEVICE FOR BLOCKING A FLUID PRODUCT RESERVOIR

(71) Applicant: APTAR STELMI SAS, Villepinte (FR)

(72) Inventors: Mickaël SWAL, Sery Magneval (FR); Mickaël Neves De Oliveira, Dammartin En Goele (FR)

(73) Assignee: APTAR STELMI SAS, Villepinte (FR)

(21) Appl. No.: 17/860,422

(22) Filed: Jul. 8, 2022

(30) Foreign Application Priority Data
Jul. 9, 2021 (FR) 2107511

(51) Int. Cl. B65D 41/04

(52) U.S. Cl. CPC B65D 41/0442; B65D 2543/00092; B65D 2543/00296

(57) ABSTRACT

Device for blocking a fluid product reservoir with a neck, having a cap, a fixing ring to hold the cap on the neck, the fixing ring having a cylindrical structure with wall parts separated by lateral windows, each wall part having at least one inner radial projection to hold the cap in the fixing ring, each lateral window having a lower edge provided with at least one rigid lug extending radially inwards from the lower edge. The rigid lugs, in the blocking position of the fixing ring, are arranged under a neck of the reservoir, to thus fix the fixing ring on the reservoir. A blocking cover is provided having a cylindrical wall and an upper wall and arranged around the fixing ring to lock said fixing ring in its blocking position. The upper surface of the cap has a deformation profile that engages, after assembly, with the fixing ring.

The present invention relates to a device for blocking a fluid product reservoir, for example a vial containing a pharmaceutical fluid product. A favoured field of application of the present invention is that of freeze-drying caps which could be pierced using a needle. The present invention also relates to a method for manufacturing such a blocking device.

Generally, a freeze-drying cap comprises a cap made of substantially flexible material, such as an elastomer, which is forcefully inserted into the neck of the reservoir. Means for positioning the cap in an intermediate position, partially assembled, associated with a lateral cutout of the cap, allow a freeze-drying of the content of the reservoir in this intermediate position. After freeze-drying, the cap is pushed into its closing position, in which it blocks the reservoir in a sealed manner, and a metal ring is mounted, in particular crimped, around the cap to fix it onto the neck of the reservoir.

This known implementation involves several disadvantages.

Thus, the exchange surface between the inside and the outside of the reservoir during the freeze-drying is low, typically less than 25 mm², and it is not possible to increase the dimensions of the lateral cutout without risking making the cap inoperative in the closing position. In addition, the caps of the prior art must be siliconised, in particular for their transport and storage, in order to avoid them bonding together, but also during the freeze-drying, to avoid the cap bonding to the rack of the freeze-dryer. Another disadvantage relates to the risk of having the cap suddenly jump out of the neck of the reservoir at the end of the freeze-drying, before crimping the ring. In addition, through its structure, in particular its shape with the lateral cutout, it is difficult, even impossible, to provide a coating, such as an ETFE film, on the face of the cap which comes into contact with the medication contained in the reservoir. Moreover, the use of a metal ring, generally made of aluminium, is likely to generate metal particles during the crimping of the ring on the neck of the reservoir, potentially damaging for the fluid contained in the reservoir. More generally, the use of a metal part is disadvantageous in terms of recycling and of respecting the environment.

Documents US2021009319 and US2013312373 describe devices of the state of the art.

The present invention aims to overcome the abovementioned disadvantages.

The present invention in particular aims to provide a blocking device, which has totally no silicone.

The present invention also aims to provide a blocking device which has totally no metal.

The present invention also aims to provide a blocking device which substantially increases the exchange surface during freeze-drying.

The present invention also aims to provide a blocking device which avoids any risk of malfunction between the end of freeze-drying and the final assembly.

The present invention also aims to provide a blocking device which allows to use a cap provided with a coating on the surface in contact with the medication.

The present invention also aims to provide a blocking device which is simple and inexpensive to manufacture and to assemble.

The present invention therefore aims for a device for blocking a fluid product reservoir, comprising:
a cap,
a fixing ring to hold said cap on said reservoir, said fixing ring comprising a cylindrical structure comprising wall parts separated by lateral windows, each wall part comprising at least one inner radial projection to hold said fixing ring, each lateral window comprising a lower edge provided with at least one rigid lug extending radially inwards from said lower edge, said rigid lugs, in the blocking position of said fixing ring, being arranged under a neck of said reservoir, to thus fix said fixing ring on said reservoir,
a blocking cover comprising a cylindrical wall and an upper wall, said blocking cover being arranged around said fixing ring, to lock said fixing ring in its blocking position, the upper surface of said cap comprising a deformation profile which engages, after assembly, with said fixing ring.

Advantageously, said deformation profile comprises a peripheral groove provided with a plurality of elastically deformable axial projections.

Advantageously, said upper wall of said blocking cover comprises flexible wall parts, separated by radial grooves, said flexible wall parts, which surround said central passage, allowing to guarantee a clearance-free assembly during the fixing of said blocking cover on said fixing ring.

Advantageously, said cap is a freeze-drying cap, said fixing ring being movable on the neck between a freeze-drying position, in which the cap does not block said neck in a sealed manner, and its blocking position, in which said cap blocks said neck in a sealed manner, said blocking cover being movable on said fixing ring between a freeze-drying position and its blocking position, in which it locks said fixing ring in its blocking position.

Advantageously, each wall part of said fixing ring comprises at least one first outer radial projection and at least one second outer radial projection, said first and second outer radial projections being axially offset from one another.

Advantageously, said blocking cover comprises, in its cylindrical wall, at least one inner radial profile, which, in the freeze-drying position, is wedged between said first and second outer radial projections of said fixing ring, to thus hold said blocking cover in its freeze-drying position on said fixing ring.

Advantageously, said cylindrical structure of said fixing ring comprises an axially lower edge comprising profiles projecting radially inwards, which, in the freeze-drying position, are arranged under the neck of said reservoir to hold said fixing ring on said reservoir in the freeze-drying position.

Advantageously, said lower edge of each lateral window comprises an outer radial profile extending radially outwards from said lower edge, said blocking cover comprising, in its cylindrical wall, at least one inner radial profile, such that in the blocking position of said blocking cover, said at least one inner radial profile is snap-fitted under said outer radial profiles of the fixing ring, to hold said blocking cover on said fixing ring in its blocking position.

Advantageously, in the freeze-drying position, the exchange surface between the inside and the outside of said reservoir is greater than 50 mm², advantageously around 80 mm².

Advantageously, said fixing ring comprises a substantially flat upper plate comprising a central opening, said blocking cover comprising an upper wall defining a central passage aligned with said central opening of said fixing ring, said device comprising a removable patch fixed on the outer surface of said upper wall of said blocking cover, to close said central passage.

Advantageously, said patch comprises foldable tabs, adapted to be folded under an edge of said central passage.

Advantageously, said device has no silicon.

Advantageously, said device has no metal.

Advantageously, said cap comprises, on its lower surface, rotated inwards from said reservoir, a coating, in particular a thin ETFE (ethylene tetrafluoroethylene) film, in order to limit the interactions between said cap and said fluid product.

The present invention also aims for an assembly comprising a fluid product reservoir comprising a neck provided with a blocking device such as described above to hold a cap on said neck.

The present invention also aims for a method for assembling a blocking device such as described above, comprising the following steps:
providing an assembly machine of the trimming type, comprising a matrix, made in the form of a hollow sleeve, and a punch associated with an ejector engaging with said matrix,
moulding a fixing ring, and arranging said fixing ring on a first side of said matrix,
moulding a sheet without silicone, in particular made of rubber, and arranging said sheet on a second side of said matrix,
moving said punch together with said ejector with respect to said matrix to cut a cap in said sheet and to bring it opposite said fixing ring,
moving said ejector with respect to said matrix to push and fix said cap in said fixing ring.

These and other characteristics and advantages of the present invention appear more clearly from the following detailed description, given by way of non-limiting examples, and with reference to the accompanying drawings, and in which:

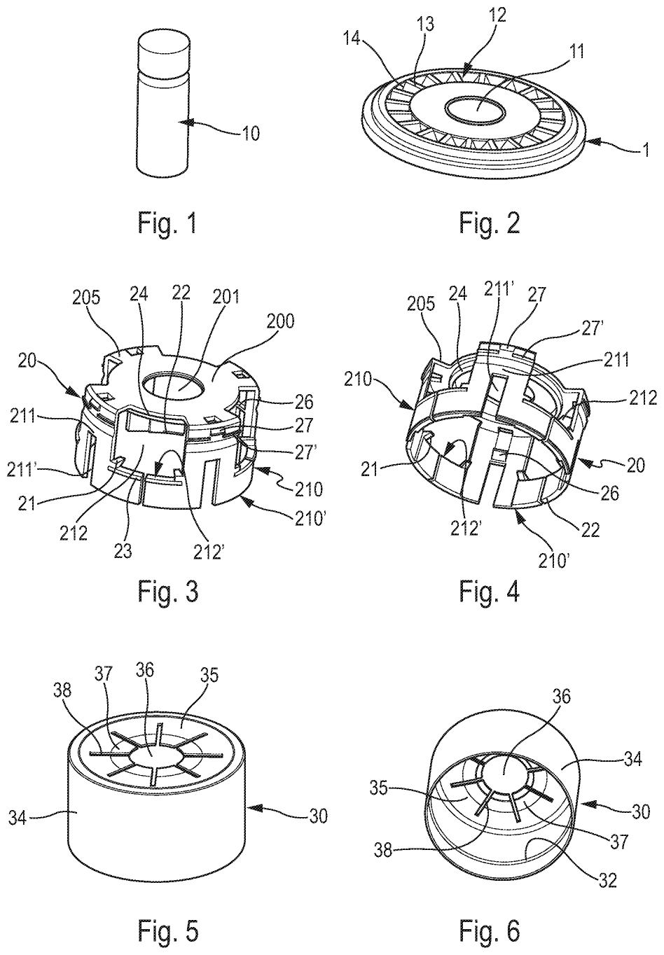

FIG. 1 is a schematic side view of a reservoir provided with a blocking device,

FIG. 2 is a schematic top, perspective view of a cap according to an advantageous embodiment,

FIG. 3 is a schematic top, perspective view of a fixing ring according to an advantageous embodiment,

FIG. 4 is a view similar to that of FIG. 3, from below,

FIG. 5 is a schematic top, perspective view of a blocking cover according to an advantageous embodiment, and

FIG. 6 is a view similar to that of FIG. 5, from below.

The terms “axial” and “radial” refer to the longitudinal central axis of the device. The terms “top”, “bottom”, “upper” and “lower” refer to the upright position of the device represented in FIG. 1.

A reservoir 10, which can be made of plastic or made of glass, is formed with a neck at its upper end. The reservoir can, in particular, be presented in the form of a vial.

A cap 1 made of elastically deformable material, like for example rubber or any other elastomer material, is provided to sealingly block the reservoir 10. This cap 1 comprises a cylindrical plate which, in the blocking position, presses on the upper edge of the reservoir 10. Advantageously, the lower surface of the cap 1 which comes into contact with the fluid product contained in the reservoir 10, can be provided with a coating, in particular, a thin ETFE (ethylene tetrafluoroethylene) film, in order to limit the interactions between the cap 1 and the fluid product.

A fixing ring 20 is provided to fix the cap 1 on the reservoir 10. The ring 20 is movable between a freeze-drying position, in which the freeze-drying can be done, and a blocking position, in which the cap 1 blocks the reservoir 10 in a sealed manner.

A blocking cover 30 is provided around the fixing ring 20, said blocking cover 30 being movable between a freeze-drying position, in which it engages with an upper part of the fixing ring 20, and an assembled position, in which it blocks the fixing ring 20 in its blocking position on the reservoir 10.

The cap 1 has an outer diameter adapted to the inner diameter of the fixing ring 20, in order to not move when it is arranged in the ring. The central part of the cap 1 forms a tapping zone 11. The upper surface of the cap 1 comprises a deformation profile 12 which engages, after assembly, with the fixing ring 20, to diffuse the stresses on the neck of the reservoir 10, while allowing to axially compensate for the dimensional variations. This deformation profile 12 advantageously comprises a peripheral groove 14 provided with a plurality of elastically deformable axial projections 13.

The fixing ring 20 has a general, cylindrically-shaped structure, with a substantially flat upper plate 200 comprising a central opening 201 aligned with the tapping zone 11 of the cap 1. The lower part axially opposite to the upper plate 200 is open to receive the reservoir 10. The upper plate 200 is connected to a cylindrical structure 210, for example by radial crosspieces 205. The cylindrical structure 210 comprises wall parts 211 separated by lateral windows 212, opened upwards. In the example of FIGS. 3 and 4, there are four wall parts 211 and four lateral windows 212 arranged alternately over the periphery of the cylindrical structure 210. A different number of these elements is possible, for example, three. Each wall part 211 can comprise a cross-section 211′ opened downwards.

The upper plate 200 comprises at least one axial projection 24, advantageously peripheral, in the proximity of the central opening 201. The axial projection 24 engages during the assembly with the deformation profile 12 of the cap 1, to compensate for the dimensional variations of the cap 1 and/or of the fixing ring 20 and/or of the reservoir 10. This also maintains a sufficient pressure on the cap 1, in order to guarantee the sealing and therefore the integrity of the fluid product contained in the reservoir 10.

Each wall part 211 comprises at least one inner radial projection 26 which is used to hold the cap 1 in the fixing ring during the assembly of the blocking device on the reservoir 10. During the assembly of the blocking device, the cap 1 is pushed against the upper plate 200 of the fixing ring, and is snap-fitted on said inner radial projections 26 of the wall parts 211. The cap 1 is thus wedged between the plate 200 and the inner radial projections 26, which holds the cap 1 fixedly in the fixing ring 20.

Each wall part 211 comprises at least one first outer radial projection 27 and at least one second outer radial projection 27′, which are used to hold the blocking cover 30 in its freeze-drying position on the fixing ring 20. The two outer radial projections 27, 27′ are offset axially from one another. Advantageously, each wall part 211 comprises a first outer radial projection 27 surrounded by two second outer radial projections 27′, as can be seen in FIGS. 3 and 4.

Each lateral window 212 comprises a lower edge 212′ provided with at least one rigid lug 21 extending radially inwards from said lower edge 212′. In the example of FIGS. 3 and 4, there are two lugs 21, on each lateral side of said lower edge 212′. In addition, said lower edge 212′ of each lateral window 212 comprises an outer radial profile 23 extending radially outwards from said lower edge 212′. In the blocking position of the fixing ring 20, the rigid lugs 21 of the fixing ring 20 are arranged under the neck of the reservoir 10, thus fixing said ring 20 on said reservoir.

The axially lower edge 210′ of the cylindrical structure 210 comprises profiles 22 projecting radially inwards. In the freeze-drying position, the profiles 22 projecting inwards are arranged under the neck of the reservoir 10 and the rigid lugs 21 are arranged on the neck of the reservoir 10. This allows to hold the fixing ring 20 on the neck of the reservoir 10 in the freeze-drying position.

The blocking cover 30 comprises a cylindrical wall 34 closed on an axial side by an upper wall 35 defining a central passage 36 which is aligned with the opening 201 of the fixing ring 20 and the tapping zone 11 of the cap 1. The upper wall 35 advantageously comprises flexible wall parts 37, separated by radial grooves 38. These flexible wall parts 37, which surround the central passage 36, allow to guarantee a clearance-free assembly during the fixing of the blocking cover 30 on the fixing ring 20.

A removable patch (not represented) is fixed on the outer surface of the upper wall 35 of the blocking cover 30, to close said central passage 36. Advantageously, said patch can comprise foldable tabs adapted to be folded under the edge of said central passage 36. When the use wants to use the fluid product contained in the reservoir 10, it removes the patch from the blocking cover 30, in particular by removal, which allows it to access the reservoir 10 with a needle adapted to pierce the cap 1 after being passed through the central passage 36 of the blocking cover and the central opening 201 of the fixing ring 20.

The blocking cover 30 comprises, in the lower part of its cylindrical wall 34, at least one inner radial profile 32. Advantageously, said inner radial profile 32 extends over the whole periphery of the cylindrical wall 34.

In the freeze-drying position, said inner radial profile 32 is wedged between the first and second outer radial projections 27, 27′ of the fixing ring 20, to thus hold the blocking cover on the fixing ring 20, in its freeze-drying position.

After freeze-drying, an axial thrust is exerted on the blocking cover 30, which will first move the fixing ring 20 in its blocking position, with the rigid lugs 21 which pass under the neck of the reservoir 10. When the fixing ring 20 arrives in the blocking position, the cap 1 is compressed on the reservoir 10, which guarantees the sealed blocking. Simultaneously, the blocking cover 30 is moved towards its blocking position to lock the fixing of the blocking device on the reservoir 10.

In the assembled position of the blocking cover 30, i.e. the blocking position, with the fixing ring 20 in the blocking position, the rigid lugs 21 of the fixing ring 20 are arranged under the neck of the reservoir. This locks the fixing of the blocking device on the neck. Moreover, in this assembled position of the blocking cover 30, the inner radial profile 32 of the blocking cover 30 is snap-fitted under the outer radial profiles 23 of the fixing ring 20, to thus fixedly hold the blocking cover 30 in its assembled position.

The assembly method uses an assembly machine of the trimming type, comprising a matrix, made in the form of a hollow sleeve, receiving on one side, a fixing ring, and on the other side, a sheet, typically made of rubber, to form the caps. A punch associated with an ejector engages with said matrix, as explained below.

The sheet exits from the silicone-free moulding step and is positioned on the upper edge of the matrix. The fixing ring, injected beforehand in the clean room, is arranged on the opposite edge of the matrix.

The punch and the ejector descend together, causing the cutting of the cap by shearing with the upper edge of the matrix.

When the cap separated from its sheet arrives at the fixing ring, the punch is stopped. The ejector continues its descent into the matrix, bringing the cap with it, until it comes into position in the fixing ring.

After assembly of the cap in the fixing ring, the punch and the ejector rise to their initial positions. The inner radial projections hold the cap inside the fixing ring.

Advantageously, a washing of the fixing ring is provided before or after assembly of the cap in said fixing ring.

The present invention therefore provides, in particular, the following advantages:
Because in the freeze-drying position, the cap is not at all inserted in the neck of the reservoir, the exchange surface is substantially increased, which can be greater than 50 mm²; in the example of the figures, this exchange surface is 80 mm²; the dimensions of the lateral windows 212 and of the cross-sections 211′ can be adapted to optimise this exchange surface; such an increase of the exchange surface, which can more than double with respect to the state of the art, allows to substantially accelerate the freeze-drying process; it is to be noted that this increase of the exchange surface is independent of the presence (or not) of the deformation profile 12 on the upper surface of the cap 1;
Because the cap 1 is housed in the fixing ring 20 from its manufacture, it is not necessary to siliconise the caps; indeed, these will never be in contact with one another, nor with the rack of the freeze-dryer;
Because in the freeze-drying position, the cap 1 is fixed in the fixing ring 20, there is no risk that this suddenly exits from the neck after freeze-drying;
Because it is no longer necessary to use a metal crimpable ring, in particular made of aluminium, allows to avoid the generation of potentially damaging particles and facilitates the recycling of the device.

Naturally, embodiment variants are considerable, without moving away from the scope of the present invention, such as defined by the accompanying claims.

1. Device for blocking a fluid product reservoir, comprising:
a cap,
a fixing ring to hold said cap on said reservoir, said fixing ring comprising a cylindrical structure comprising wall parts separated by lateral windows, each wall part comprising at least one inner radial projection to hold said cap in said fixing ring, each lateral window comprising a lower edge provided with at least one rigid lug extending radially inwards from said lower edge, said rigid lugs, in the blocking position of said fixing ring, being arranged under a neck of said reservoir, to thus fix said fixing ring on said reservoir,
a blocking cover comprising a cylindrical wall and an upper wall, said blocking cover being arranged around said fixing ring, to lock said fixing ring in its blocking position,
characterised in that the upper surface of said plug comprises a deformation profile which engages, after assembly, with said fixing ring.

2. Blocking device according to claim 1, wherein said deformation profile comprises a peripheral groove provided with a plurality of elastically deformable axial projections.

3. Blocking device according to claim 1, wherein said upper wall of said blocking cover comprises flexible wall parts, separated by radial grooves.

4. Blocking device according to claim 1, wherein said cap is a freeze-drying cap, said fixing ring being movable on the neck between a freeze-drying position, wherein the cap does not block said neck in a sealed manner, and its blocking position, wherein said cap blocks said neck in a sealed manner, said blocking cover being movable on said fixing ring between a freeze-drying position and its blocking position, wherein it locks said fixing ring in its blocking position.

5. Blocking device according to claim 4, wherein each wall part of said fixing ring comprises at least one first outer radial projection and at least one second outer radial projection, said first and second outer radial projections being axially offset from one another.

6. Blocking device according to claim 5, wherein said blocking cover comprises in its cylindrical wall at least one inner radial profile, which, in the freeze-drying position, is wedged between said first and second outer radial projections of said fixing ring, to thus hold said blocking cover in its freeze-drying position on said fixing ring.

7. Blocking device according to claim 4, wherein said cylindrical structure of said fixing ring comprises an axially lower edge comprising profiles projecting radially inwards, which, in the freeze-drying position, are arranged under the neck of said reservoir to hold said fixing ring-on said reservoir in the freeze-drying position.

8. Blocking device according to claim 4, wherein said lower edge of each lateral window comprises an outer radial profile extending radially outwards from said lower edge, said blocking cover comprising in its cylindrical wall at least one inner radial profile, such that in the blocking position of said blocking cover, said at least one inner radial profile is snap-fitted under said outer radial profiles of the fixing ring, to hold said blocking cover-on said fixing ring in its blocking position.

9. Blocking device according to claim 4, wherein, in the freeze-drying position, the exchange surface between the inside and outside of said reservoir is greater than 50 mm², advantageously around 80 mm².

10. Blocking device according to claim 1, wherein said fixing ring comprises a substantially flat upper plate comprising a central opening, said blocking cover comprising an upper wall defining a central passage aligned with said central opening of said fixing ring, said device comprising a removable patch fixed on the outer surface of said upper wall of said blocking cover, to close said central passage.

11. Blocking device according to claim 10, wherein said disc comprises foldable tabs adapted to be folded under an edge of said central passage.

12. Blocking device according to claim 1, wherein said device has no silicone.

13. Blocking device according to claim 1, wherein said device has no metal.

14. Blocking device according to claim 1, wherein said cap comprises a coating on its inner surface rotated inwards from said reservoir, in particular a thin ETFE (ethylene tetrafluoroethylene) film, in order to limit the interactions between said cap and said fluid product.

15. Assembly comprising a fluid product reservoir comprising a neck provided with a blocking device according to claim 1 to hold a cap on said neck.

16. Method for assembling a blocking device according to claim 1, characterised in that it comprises the following steps:
providing an assembly machine of the trimming type, comprising a matrix, made in the form of a hollow sleeve, and a punch associated with an ejector engaging with said matrix,
moulding a fixing ring, and arranging said fixing ring-on a first side of said matrix,
silicone-free moulding a sheet, in particular made of rubber, to form caps, and arranging said sheet on a second side of said matrix,
moving said punch together with said ejector with respect to said matrix to cut a cap in said sheet and bring it opposite said fixing ring,
moving said ejector with respect to said matrix to push and fix said cap in said fixing ring.
